(19) United States
(12) Patent Application Publication
(10) Pub. No.: US 2012/0318525 A1
(43) Pub. Date: Dec. 20, 2012

(54) TUBULAR VALVING SYSTEM, BODY AND METHOD OF OPENING

(75) Inventors: Anthony S. Coghill, Tulsa, OK (US); Dale W. Schubert, Collinsville, OK (US); Lisa D. Crase, Broken Arrow, OK (US); Thomas S. Myerley, Broken Arrow, OK (US); Michael J. May, Broken Arrow, OK (US)

(73) Assignee: BAKER HUGHES INCORPORATED, Houston, TX (US)

(21) Appl. No.: 13/160,736

(22) Filed: Jun. 15, 2011

(51) Int. Cl. E21B 34/06; F16K 27/00; E21B 34/00

(52) U.S. Cl. 166/373; 166/332.3; 251/366

(57) ABSTRACT

A valving system includes, a tubular having a seat, and a body with a bore therethrough having a surface sealably engagable with the seat, the body being rotatable relative to the tubular between at least a first position, a second position and a third position, the first position occluding flow between an inside of the tubular and the bore the second position providing fluidic communication between the inside of the tubular and the bore via at least one cavity formed in the surface and a third position providing direct fluidic communication between the inside of the tubular and the bore

### BACKGROUND

Ball valves are commonly used in tubular systems to control flow. In addition to having good sealing characteristics ball valves supply unrestricted flow when fully opened. Compliant seals, embedded in the valve housing for example, slidably sealingly engage with the rotatable spherical surface of the ball to improve sealing integrity. The compliant seal is often made of a flexible material that is not as hard as the ball or the valve housing, and has been known to experience erosion that can detrimentally affect sealing integrity of the valve. Systems and methods to overcome the foregoing drawbacks are well received in the art.

### BRIEF DESCRIPTION

Disclosed herein is a tubular valving system. The valving system includes, a tubular having a seat, and a body with a bore therethrough having a surface sealably engagable with the seat, the body being rotatable relative to the tubular between at least a first position, a second position and a third position, the first position occluding flow between an inside of the tubular and the bore the second position providing fluidic communication between the inside of the tubular and the bore via at least one cavity formed in the surface and a third position providing direct fluidic communication between the inside of the tubular and the bore.

Further disclosed herein is a method of opening a tubular valve. The method includes, sealing a body having a bore and a surface to a tubular seat, rotating the body relative to the tubular seat, crossing the tubular seat with a portion of at least one cavity formed in the surface, opening fluidic communication between an inside of a tubular and the bore via the portion of at least one cavity, and crossing the tubular seat with the bore.

Further disclosed herein is a body of a tubular valve. The body includes, a rigid material having a partially spherical surface being slidably sealingly engagable with a tubular seat, the partially spherical surface having a plurality of cavities formed therein configured to provide a plurality of flow passageways between the body and the tubular seat in response to rotation of the body relative to the tubular seat prior to a portion of a bore through the body providing a flow passageway between the body and the tubular seat.

### BRIEF DESCRIPTION OF THE DRAWINGS

The following descriptions should not be considered limiting in any way. With reference to the accompanying drawings, like elements are numbered alike:

FIG. 1 depicts a partial perspective view of a tubular valving system disclosed herein with tubulars shown as translucent;

FIG. 2 depicts a perspective view of a body of the tubular valving system of FIG. 1;

FIG. 3 depicts an alternate perspective view of the body of FIG. 2; and

FIG. 4 depicts a perspective view of an end of a tubular of the tubular valving system of FIG. 1.

### DETAILED DESCRIPTION

A detailed description of one or more embodiments of the disclosed apparatus and method are presented herein by way of exemplification and not limitation with reference to the Figures.

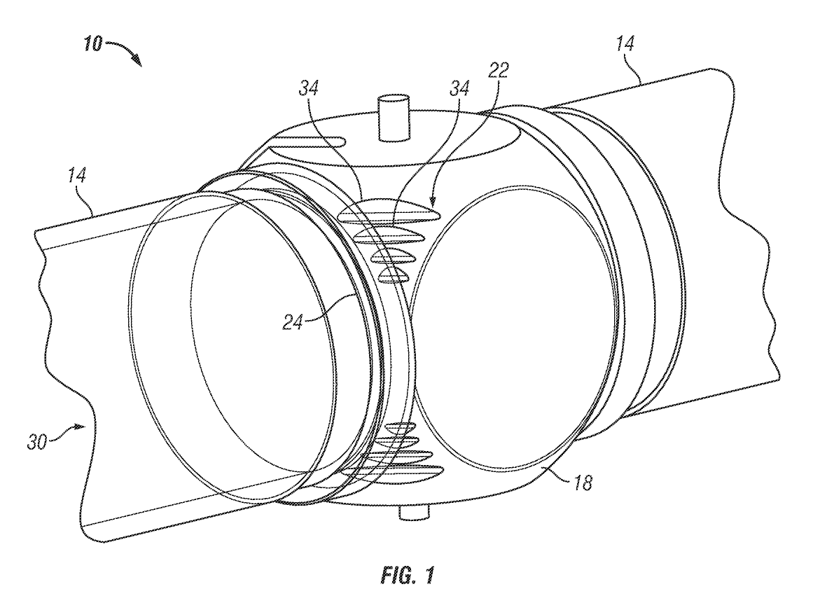

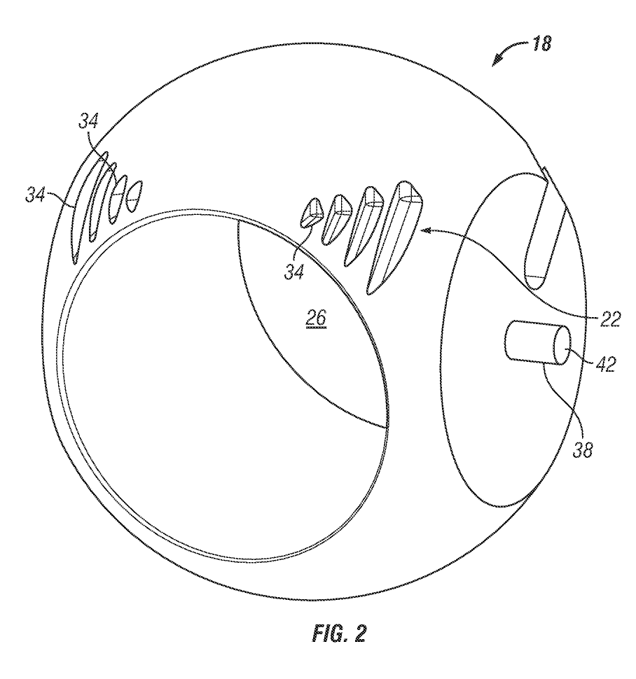

Referring to FIG. 1, an embodiment of a tubular valving system disclosed herein is illustrated at 10. The valving system 10 includes, at least one tubular 14, with two tubulars being shown in the embodiment of this Figure although only one tubular is described in detail, and a body 18. The body 18 is movably engaged relative to the tubular 14 and has a surface 22 that is sealingly slidably engaged with a seat 24 of the tubular 14. The body 18 has at least three positions relative to the tubular 14 that are defined by fluidic communication between a bore 26 (FIG. 2) therethrough and an inside 30 of the tubular 14. The first position (as shown in FIG. 1) provides no fluidic communication between the bore 26 and the inside 30 of the tubular 14. The second position (not illustrated) provides fluidic communication between the bore 26 and the inside 30 of the tubular 14 via at least one cavity 34 formed in the surface 22, and the third position (not illustrated) provides fluidic communication between the bore 26 and the inside 30 of the tubular 14 directly. Although the cavities 34 illustrated herein are in the form of grooves, they could also be large shallow indentations in the surface 22 or holes that breach the surface 22 in two separate locations.

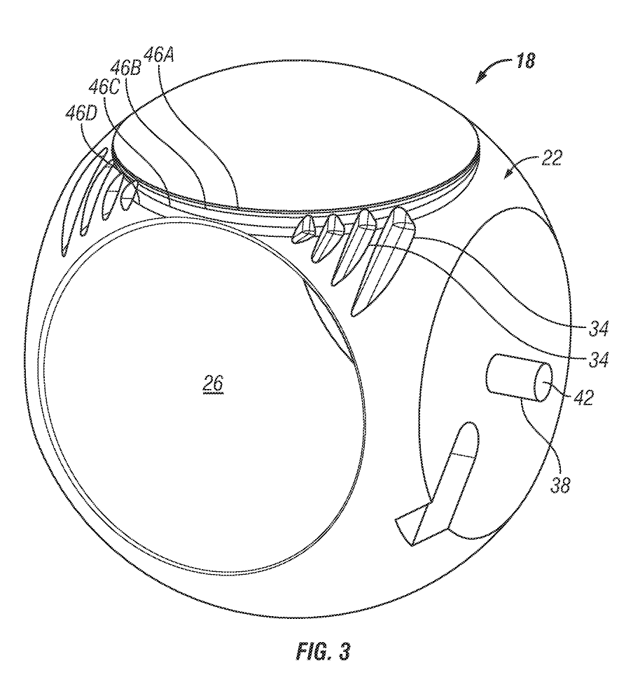

Referring to FIGS. 2 and 3, the body 18 rotates about an axle 38 that defines a pivot axis 42. Although the body 18 in this embodiment has the shape of a sphere, other shapes, such as that of a cylinder or an ellipsoid, for example, are also contemplated. The surface 22 slidably sealingly engages with the tubular 14 as the body 18 rotates. Fluidic communication between the inside 30 of the tubular 14 and the bore 26 is fully occluded until at least a portion of one of the cavities 34 crosses over a virtual line 46A-46D (shown on surface in FIG. 3 but not in FIG. 2) that represents the point of sealing with the tubular 14. Full occlusion of fluidic communication exists at the line 46A as can be observed by noting that none of the cavities 34 or the bore 26 crosses the line 46A. Fluidic communication between the inside 30 of the tubular 14 and the bore 26 occurs through the four cavities 34 (two on either side) that are closest to the axle 38 but not through the four cavities 34 (two to either side) that are farthest from the axle 38 when sealing is at the line 46B. When sealing at the line 46C all eight of the cavities 34 shown provide fluidic communication between the inside 30 of the tubular 14 and the bore 26 while the bore 26 itself is still not in direct fluid communication with the bore 26. And at the line 46D fluidic communication is established between the inside 30 of the tubular 14 and the bore 26 directly in addition to through the eight cavities 34. It should be noted that selective placement of the cavities 34 relative to the lines 46A-46D can vary the order and timing associated when each of the cavities 34 establish fluidic communication relative to when the bore 26 establishes direct fluidic communication with the inside 30 of the tubular 14. By having the cavities 34 establish fluidic communication in response to rotation of the body 18 before the bore 26 directly does, erosion of a portion of the tubular 14, such as the seat 24, sealed to the body 18 can be reduced. Having all of the cavities 34 simultaneously establish fluidic communication in response to rotation of the body 18 may have the greatest beneficial effect for the seat 24.

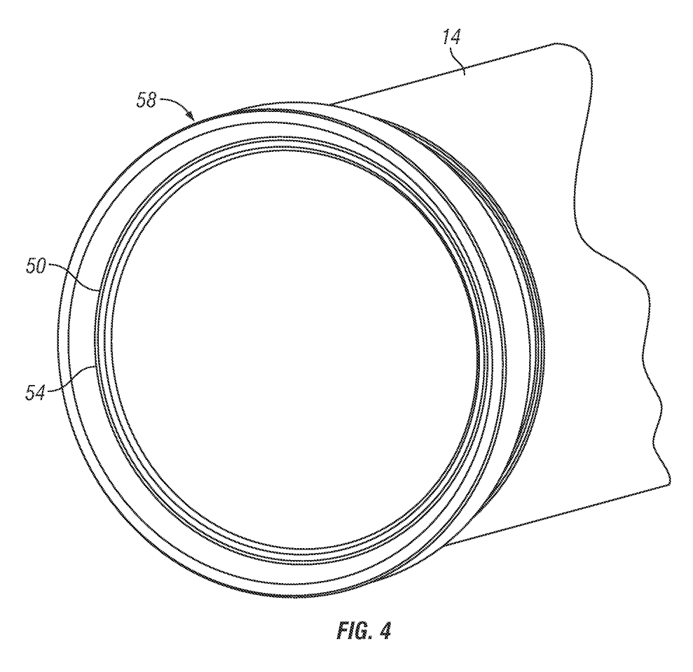

Referring to FIG. 4, the tubular 14 is illustrated without the body 18 to show the seat 24, in this embodiment that includes a seal 50. The seal 50 is partially recessed within a channel 54 formed in an end 58 of the tubular 14. The seal 50 can be made of any of a variety of materials, including materials that are more resilient than the tubular 14 or the body 18, which may both be metal, to facilitate sealing over imperfections or contamination on the surface 22. Examples of such materials include polytetrafluoroethylene (PTFE) and Polyether ether ketone (PEEK). When the seal 50 is made of a resilient material, erosion and dislodgement of the seal 50 due to flow thereby can occur more easily. As such, creating fluid communication between the inside 30 of the tubular 14 and the bore 26 through a plurality of the cavities 34 can reduce the likelihood of both erosion and dislodgement from the channel 54. Large pressure differentials across the valving system 10 prior to opening will result in high flow rates across the seal 50 as soon as fluidic communication is initiated. Without the cavities 34 no pressure would be relieved between the inside 30 of the tubular 14 and the bore 26 until the bore 26 itself crossed the line 46C, at which time all the pressure and flow would flow through the single formed opening. Additionally, with very little rotation of the body 18 a large length of the seal 50 becomes uncompressed between the tubular 14 and the body 18. This lack of compression of the seal 50 and the high velocity of flow across the seal 50 can increase the likelihood that the seal 50 will be urged from the channel 54 and negatively impact sealing upon subsequent closing of the valving system 10.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A tubular valving system comprising:
a tubular having a seat; and
a body with a bore therethrough having a surface sealably engagable with the seat, the body being rotatable relative to the tubular between at least a first position, a second position and a third position, the first position occluding flow between an inside of the tubular and the bore the second position providing fluidic communication between the inside of the tubular and the bore via at least one cavity formed in the surface and a third position providing direct fluidic communication between the inside of the tubular and the bore.

2. The tubular valving system of claim 1, wherein the at least one cavity is a plurality of cavities.

3. The tubular valving system of claim 2, wherein each of the plurality of cavities provide fluidic communication between the inside of the tubular and the bore substantially simultaneously in response to rotation of the body.

4. The tubular valving system of claim 2, wherein the plurality of cavities are oriented substantially symmetrically about a plane orthogonal to an axis of rotation of the body.

5. The tubular valving system of claim 1, wherein rotation of the body from the second position occurs before the third position as the body is rotated.

6. The tubular valving system of claim 1, further comprising a seal located at the seat.

7. The tubular valving system of claim 6, wherein the seal is located at least partially within a channel in the tubular.

8. The tubular valving system of claim 6, wherein the seal includes material selected from the group consisting of polytetrafluoroethylene (PTFE) and Polyether ether ketone (PEEK).

9. The tubular valving system of claim 1, wherein an axis of rotation of the body is substantially orthogonal to a longitudinal axis of the tubular.

10. The tubular valving system of claim 1, wherein the body is at least partially spherical.

11. A method of opening a tubular valve comprising:
sealing a body having a bore and a surface to a tubular seat;
rotating the body relative to the tubular seat;
crossing the tubular seat with a portion of at least one cavity formed in the surface;
opening fluidic communication between an inside of a tubular and the bore via the portion of at least one cavity; and
crossing the tubular seat with the bore.

12. The method of opening a tubular valve of claim 11, further comprising opening fluidic communication between the inside of the tubular and the bore directly

13. The method of opening a tubular valve of claim 11, further comprising decreasing pressure differential across the tubular seat with the opening of fluidic communication via the portion of the at least one cavity.

14. The method of opening a tubular valve of claim 11, wherein the surface it at least partially spherical.

15. The method of opening a tubular valve of claim 11, wherein the sealing the body to the tubular seat includes sealing the body to a seal and sealing the tubular to the seal.

16. The method of opening a tubular valve of claim 11, further comprising opening fluidic communication between an inside of a tubular and the bore via a plurality of portions of the at least one cavity.

17. A body of a tubular valve comprising, a rigid material having a partially spherical surface being slidably sealingly engagable with a tubular seat, the partially spherical surface having a plurality of cavities formed therein configured to provide a plurality of flow passageways between the body and the tubular seat in response to rotation of the body relative to the tubular seat prior to a portion of a bore through the body providing a flow passageway between the body and the tubular seat.
